(19) United States
(12) Patent Application Publication
(10) Pub. No.: US 2012/0266640 A1
(43) Pub. Date: Oct. 25, 2012

(54) Lock With Pin Tumblers and Lever Tumblers

(76) Inventor: Eugene F. DAUGHERTY, San Antonio, TX (US)

(21) Appl. No.: 13/089,768

(22) Filed: Apr. 19, 2011

(51) Int. Cl. E05B 27/02

(52) U.S. Cl. 70/493

(57) ABSTRACT

A lock is disclosed having a set of pin tumblers in the lock cylinder in addition to the lever tumblers to prevent rotation of the cylinder without a key to release the driver pins that engage the cylinder and prevent rotation. The key has pin tumbler cuts on the edge of the key. Because the pin tumblers and the related pin tumbler cuts on the edge of key can be spaced randomly along the length of the key and because the lengths of the pin tumblers and the depths of the pin tumbler cuts in the key can be random, the ability to create a duplicate key rendered substantially more difficult then a key with only lever tumbler cuts.

### FIELD OF THE INVENTION

This invention relates to a deadbolt lock, and more particularly to a prison cell deadbolt lock that incorporates both pin tumblers and lever tumblers to increase the difficulty of fabricating a duplicate key for the lock.

### BACKGROUND OF THE INVENTION

A prison cell lock conventionally is a deadbolt lock that incorporates lever tumblers for the lock. A key for such a conventional deadbolt lock with lever tumblers has key cuts that are rectangular and have depths that are multiples of usually the same increment. In the environment of a prison cell lock, prison inmates may be able to “read” the key cuts and thereby fashion a duplicate key. Moreover, a soft material may be used to acquire impressions of the key grooves and the key cut positions within the cylinder of the lock.

### SUMMARY OF THE INVENTION

In order to solve the problems associated with the possible fashioning of a duplicate key by “reading” the key cuts from observing the key and/or by taking an impression of the keyway of the lock cylinder, the lock of the present invention incorporates a set of pin tumblers in the cylinder in addition to the lever tumblers. The pin tumblers engage pin tumbler cuts on the edge of the key. Because the pin tumblers and the related pin tumbler cuts on the edge of key can be spaced randomly along the length of the key and because the lengths of the pin tumblers and the depths of the pin tumbler cuts on the edge of the key can be random, the ability to create a duplicate key by “reading” the pin tumbler cuts on the edge of the key including reading the spacing and depth of the pin tumbler cuts on the edge of the key is greatly reduced. Moreover, taking an impression of the keyway to ascertain the configuration of the pin tumbler cuts on the edge of the key is rendered substantially more difficult.

Further objects, features and advantages will become apparent upon consideration of the following detailed description of the invention when taken in conjunction with the drawings and the appended claims.

### BRIEF DESCRIPTION OF THE DRAWINGS

FIG. 1 is a perspective view of a lock and key in accordance with the present invention.

FIG. 2A-2E is a series of front elevation views of the lock, with the lock cover removed, showing the progression of positions of the lock from a locked position (FIG. 2A) to an unlocked position (FIG. 2E) in accordance with the present invention.

FIGS. 3A-3C is a series of section views of the lock showing the progression of positions of the lock from a locked position (FIG. 3A) to an unlocked position (FIG. 3C) in accordance with the present invention as seen along line 3A-3A of FIG. 2A, along line 3B-3B of FIG. 2C, and along line 3C-3C of FIG. 2E.

FIG. 4 is a detail side elevation view of the cylinder of the lock in accordance with the present invention.

FIG. 5 is a detail bottom plan view of the cylinder of the lock in accordance with the present invention.

FIG. 6 is a detail front elevation view of the cylinder of the lock in accordance with the present invention.

FIG. 7 is a detail side elevation view of the driver pin housing of the lock in accordance with the present invention.

FIG. 8 is a section elevation view of the driver pin housing of the lock in accordance with the present invention as seen along line 8-8 of FIG. 7.

FIG. 9 is a detail elevation view of the driver pin housing and the cylinder, partially in section, of the lock in accordance with the present invention.

### DETAILED DESCRIPTION OF THE PREFERRED EMBODIMENT

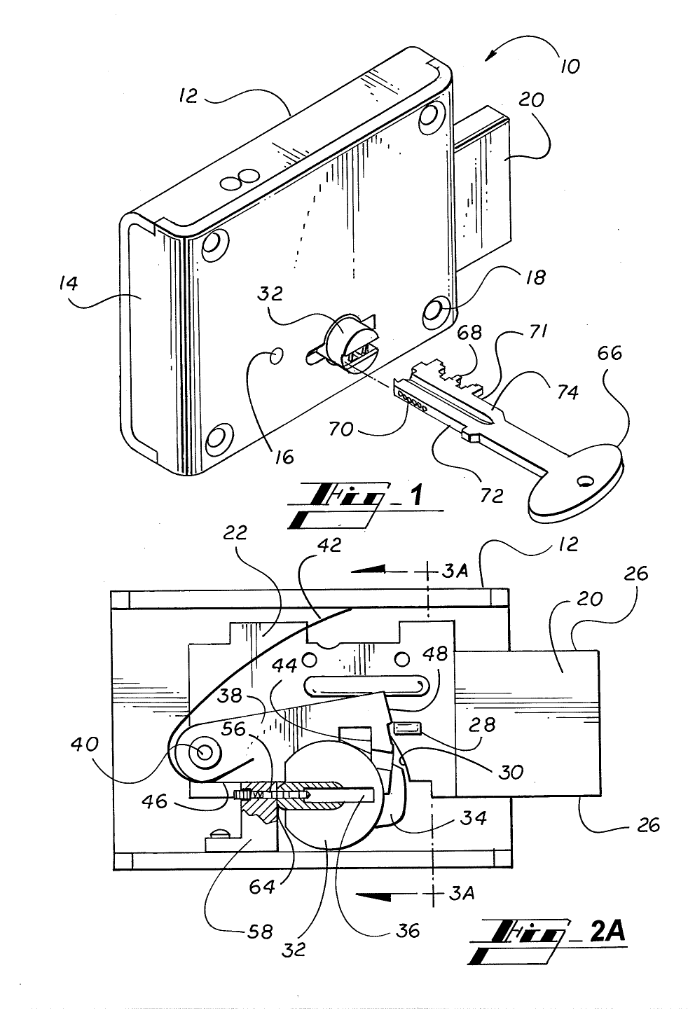

Turning to FIG. 1, a lock 10 is shown comprising a housing 12 with a cover 14. The cover 14 is held onto the housing 12 by means of a mounting screw 16. The housing 12 and the cover 14 may be mounted to a prison cell door by means of bolts (not shown) inserted through mounting holes 18. The bolts not only serve to hold the lock 10 on the prison cell door, but the bolts also serve to hold the housing 12 and the cover 14 together.

A lock bolt 20 with a connected lock plate 22 is slidably mounted within the housing 12. The lock bolt 20 has bearing surfaces 26 that engage the edges of the cover 14 to maintain alignment of the lock bolt within the housing 12. The lock bolt plate 22 also has a slot 24 that engages a pivot post 40 to provide a bearing surface to align the lock plate 22 and the lock bolt 20 within the housing 12. In addition, the lock bolt plate 22 has a lug 28 and a profiled follower surface 30. The functions of the lug 28 and the profiled follower surface 30 will be described in greater detail below.

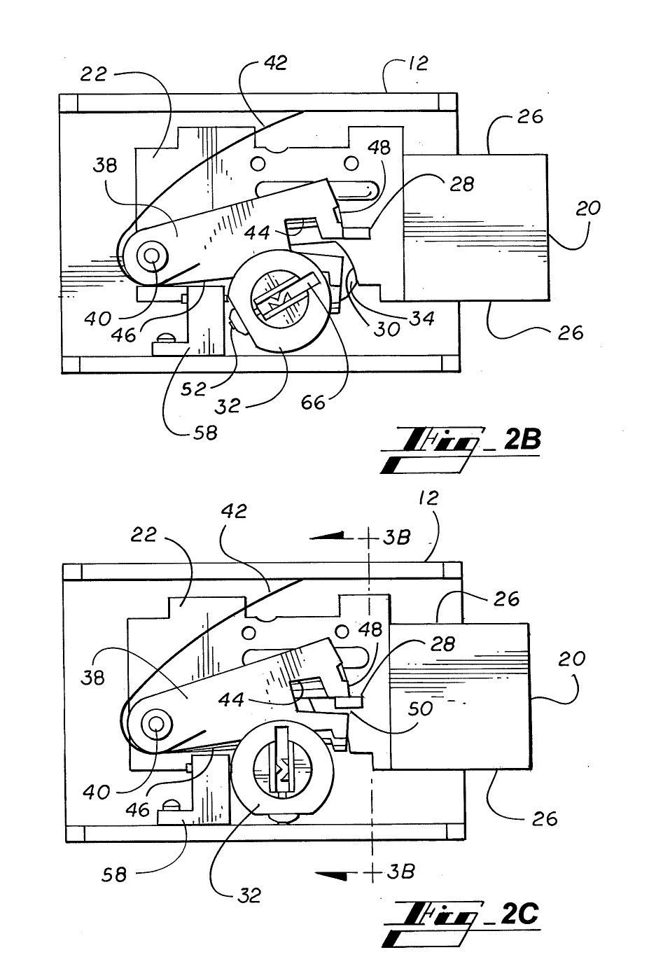

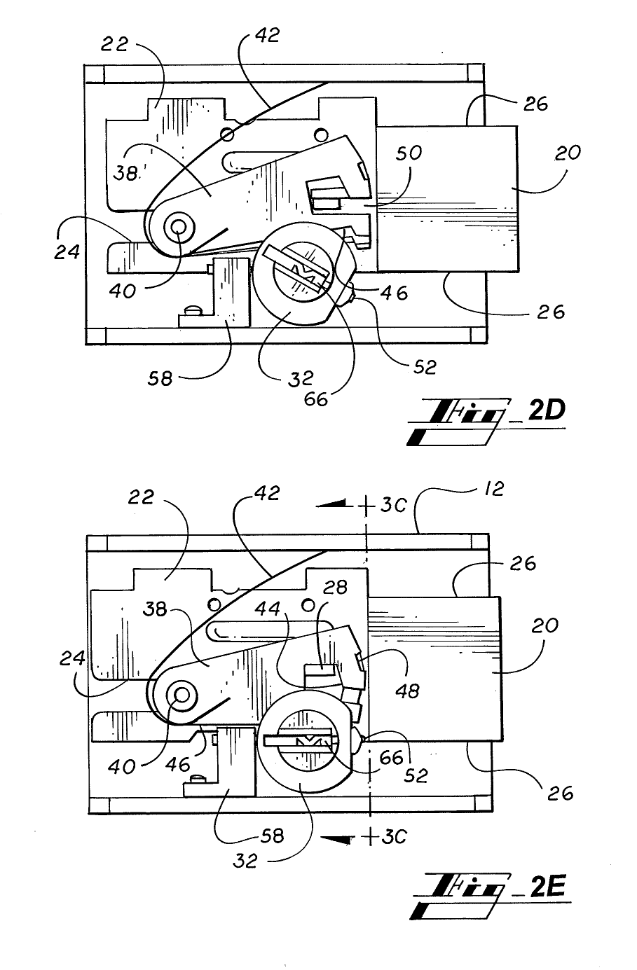

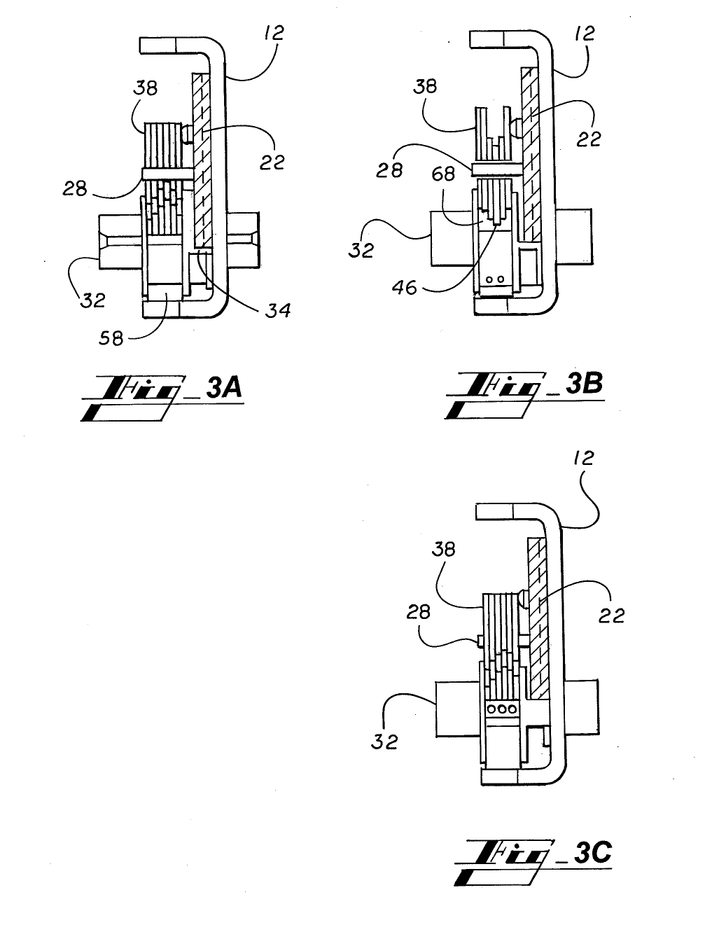

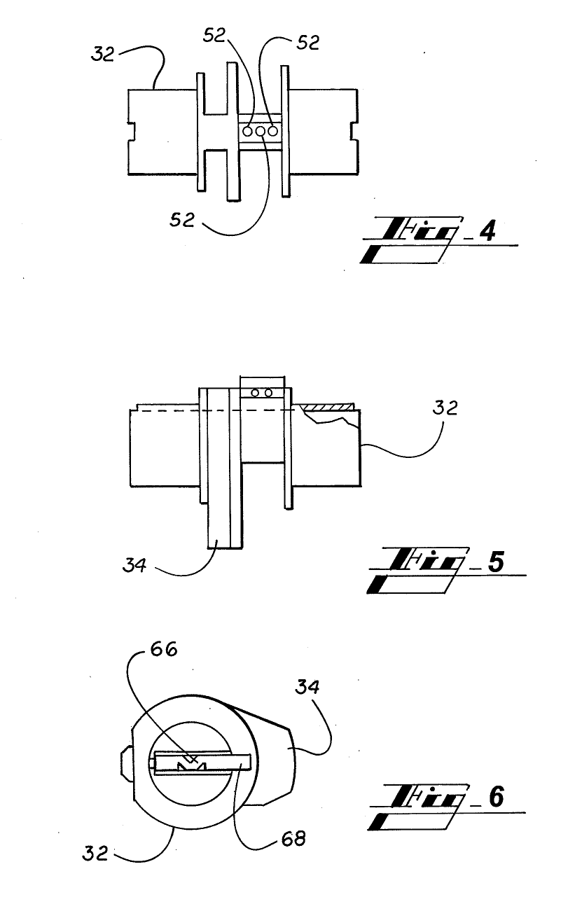

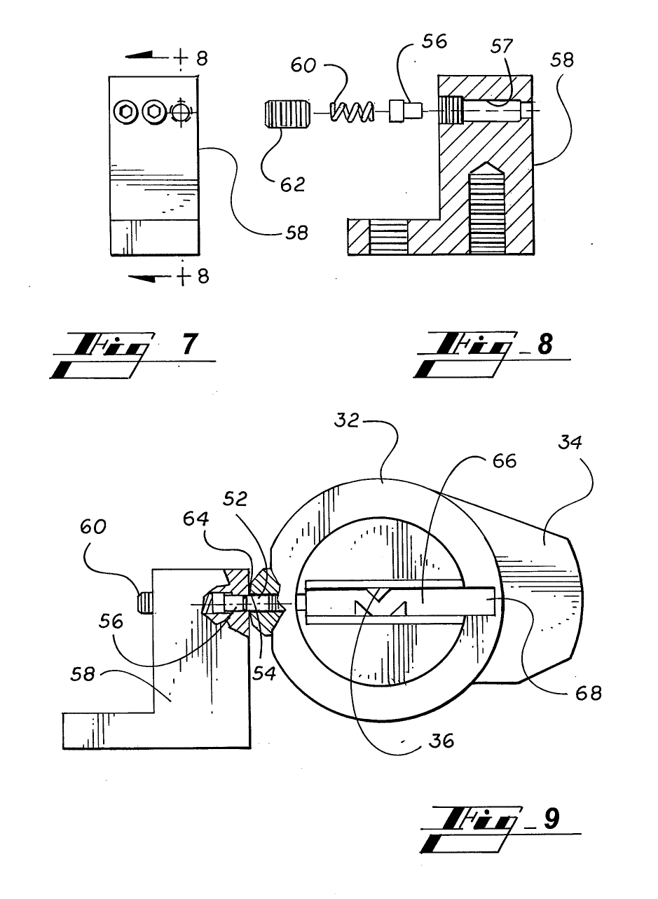

A cylinder 32 with a keyway 36 is mounted for rotation within the housing 12. The cylinder 32 includes a driving cam 34 that engages the profiled follower surface 30 of the lock bolt plate 22 in order to drive the lock plate 22 and the lock bolt 20 between an unlocked position (FIGS. 2E and 3C) and a locked position (FIGS. 2A and 3A) as the cylinder 32 is rotated by means of a key 66 inserted in the keyway 36. The key 66 has a flat blade 74 with edges 71 and 72. The edge 71 has a series of conventional lever tumbler cuts 68 that are rectangular and have depths that are multiples of usually the same increment. In accordance with the present invention, the opposite edge 72 of the flat blade 74 has a series of pin tumbler cuts 70 in the form of cylindrical bores. The spacing of the pin tumbler cuts 70 along the length of the key 66 may vary, and the depths of the pin tumbler cuts 70 may also vary. In addition, a number of dummy pin tumbler cuts 70 may be provided to disguise the number of pin tumblers that are actually incorporated into the cylinder 32 as will be described in greater detail below.

As best shown in FIGS. 4 and 9, the cylinder 32 has a set of pin tumblers 52. For purposes of illustration, three individual pin tumblers 52 are shown, but more or less pin tumblers may be used. The pin tumblers 52 are slideably mounted within radially extending pin tumbler chambers 54. With reference to FIGS. 2A-2E, 8, and 9, a driver pin housing 58 is mounted in the housing 12 adjacent the cylinder 32. The driver pin housing 58 has three driver pins 56 slideably mounted in driver pin chambers 57 (FIG. 8). While three driver pins 56 are illustrated, more or less driver pins 56 may be used to match the number of pin tumblers 52 within the cylinder 32. The driver pins 56 are biased to extend outward from the driver pin housing 58 by means of driver pin springs 60 that are mounted in the driver pin chambers 57 by means of setscrews 62. A shear line 64 is defined where the driver pins 56 engage the pin tumbler chambers 54 of the cylinder 32.

With reference to FIGS. 2A-2E and 3A-3C, a set of lever tumblers 38 are pivotally mounted on lever tumbler pivot post 40 within the housing 12. Lever tumbler springs 42 bias the lever tumblers 38 in a clockwise direction and into engagement with the cylinder 32. For the purposes of explanation, six lever tumblers 38 are illustrated. Consequently, the key 66 has six lever tumbler cuts 68 to match the six lever tumblers 38. Each lever tumbler 38 has a lever tumbler engaging surface 46 that engages the lever tumbler cuts 68 of the key 66. Each lever tumbler 38 also has a lever tumbler stop surface 48 that engages the lug 28 on the slide plate 22 in order to keep the lock bolt 20 from retracting into the housing 12 from the locked position (FIGS. 2A and 3A) to the unlock position (FIGS. 2E and 3C). Each lever tumbler 38 also has a lever tumbler notch 44 that engages the lug 28 on the slide plate 22 in order to keep the lock bolt 20 from moving from the unlock position to the locked position. Further, each lever tumbler 38 has a lever tumbler gap 50 communicating with the lever tumbler notch 44 to allow the lug 28 to move from the locked position (FIGS. 2A and 3A) to the unlock position (FIGS. 2E and 3C) when the lever tumblers 38 are aligned by means of the lever tumbler cuts 68 on the key 66.

The operation of the lock 10 is best understood by reference to FIGS. 2A-2E and 3A-3C. FIGS. 2A and 3A illustrate the lock 10 in its locked position. In FIG. 2A, the key 66 is not inserted in the keyway 36, but in FIG. 3A, the key 66 is inserted in the keyway 36 so that the relationship between the lever tumbler cuts 68 on the key 66 and the lever tumbler key engaging surfaces 46 can be shown. As shown in FIGS. 2A and 3A, the cylinder 32 is in its initial locked position with the driver pins 56 extending outwardly from the driver pin housing 58 and into the pin tumbler chambers 54 (FIG. 9) thereby preventing rotation of the cylinder 32. As further shown in FIG. 9, once the key 66 is inserted into the keyway 36, the pin tumblers 52 are forced by the action of the pin tumbler cuts 70 into engagement with the driver pins 56. The engagement of the pin tumblers 52 with the driver pins 56 aligns the ends of the driver pins 56 with the shear line 64 so that the cylinder 32 is released for rotation, in this case in a counterclockwise direction.

As the cylinder 32 rotates counterclockwise to the position shown in FIG. 2B, the lever tumbler cuts 68 of the key 66 begin to engage the lever tumbler key engaging surfaces 46 of the lever tumblers 38. The driving cam 34 of the cylinder 32 also engages the profiled follower surface 30 of the lock bolt plate 22 and thereby begins pulling the lock bolt 20 into the housing 12.

Further rotation of the cylinder 32 to the position shown in FIGS. 2C and 3B, causes the lever tumbler cuts 68 of the key 66 to move the lever tumblers 38 into a position in which the lever tumbler gaps 50 of each of the lever tumblers 38 align so that the lug 28 of the lock bolt plate 22 can be pulled through the gaps 50 into the lever tumbler notches 44 by the camming action of the driving cam 34 of the cylinder 32 engaging the profiled follower surface 30 of the lock bolt plate 22.

As the cylinder 32 rotates to the position shown in FIG. 2D, the lock bolt 20 is completely retracted into the housing 12, and the lug 28 has passed through the lever tumbler gaps 50 and is within the lever tumbler notches 44.

When the cylinder 32 rotates to the fully unlocked position shown in FIGS. 2E and 3C, the lever tumbler cuts 68 in the key 66 have allowed the lever tumblers 38 to return to their initial position thereby capturing the lug 28 within the lever tumbler notches 44 of each of the lever tumblers 38. Consequently, the lock bolt 20 cannot be moved from the unlocked position to the locked position without the use of the key 66 to release the lug 28 from the lever tumbler notches 44.

While this invention has been described with reference to preferred embodiments thereof, it is to be understood that variations and modifications can be affected within the spirit and scope of the invention as described herein and as described in the appended claims.

I claim:

1. A lock comprising:
a. a housing;
b. a lock bolt slideably mounted in the housing for sliding between a locked position and an unlocked position, the lock bolt having:
i. a follower surface; and
ii. a protruding lug;
c. a cylinder rotatably mounted in the housing having:
i. a keyway for accommodating a key;
ii. a driving surface for engaging the follower surface on the lock bolt; and
iii. a set of pin tumblers mounted in the cylinder;
d. a set of pin drivers mounted adjacent the cylinder and engaging the cylinder adjacent the pin tumblers; and
e. a set of lever tumblers mounted adjacent the cylinder that engages the lug to secure the lock bolt in the locked position and in the unlocked position.

2. The lock of claim 1, wherein the key engages the pin tumblers to release the cylinder for rotation and wherein the key engages the lever tumblers to cause the lever tumblers to engage and disengage the lug of the lock bolt.
